(19) United States
(12) Patent Application Publication
(10) Pub. No.: US 2026/0014911 A1
(43) Pub. Date: Jan. 15, 2026

(54) Head Restraint for a Vehicle Seat with a Head Restraint Guide Arrangement and Head Restraint Guide Arrangement for a Head Restraint

(71) Applicant: Illinois Tool Works Inc., Glenview, IL (US)

(72) Inventors: Stefan Fuchs, Gaukönigshofen (DE); Jorge Adolfo Miranda Nieto, Barcelona (ES); David Montes Cobo, Sabadell (ES)

(21) Appl. No.: 19/243,504

(22) Filed: Jun. 19, 2025

(30) Foreign Application Priority Data
Jul. 9, 2024 (DE) 10 2024 119 482.0

(51) Int. Cl. B60N 2/815; B60N 2/818; B60N 2/897

(52) U.S. Cl. CPC B60N 2/815; B60N 2/818; B60N 2/897

(57) ABSTRACT

The disclosure relates to a vehicle seat headrest that includes two roughly parallel support rods. A head cushion is, or can be, mounted on these rods. The headrest also features a locking mechanism-typically operated by hand-that locks only one of the two rods or a part of one rod. This lock includes a rotary knob, which, when turned, disengages the locking element from the rod to allow adjustment or removal.

### RELATED APPLICATION

The present application claims the benefit of German Patent Application No. 10 2024 119 482.0, filed Jul. 9, 2024, titled “Head Restraint for a Vehicle Seat with a Head Restraint Guide Arrangement and Head Restraint Guide Arrangement for a Head Restraint,” the contents of which are hereby incorporated by reference.

### BACKGROUND

Headrests are an essential part of the passive safety system in vehicles and serve to reduce the effects of forces on the cervical spine when vehicle movement changes suddenly, in particular during a traffic accident. In addition to improving safety for the vehicle occupants, headrests are also used in order to increase comfort.

In order for headrests to take over these functions and be individually adaptable to different vehicle occupants in terms of their position, they are typically adjustable. Various designs and variants are known with regard to the adjustment options.

Typically, headrests are at least height-adjustable and are mechanically lockable at different positions. For this purpose, the headrests comprise headrest rods with locking points as well as a cushioned support structure (head pads) that are held in corresponding receptacles of the vehicle seat.

In the case of mechanically adjustable headrests, it is particularly essential that the operation and adjustability for a vehicle occupant is possible in a fast, simple manner and with little effort, and that optimum, individual adjustment can be achieved for different occupants. Furthermore, the manufacture and assembly of the headrests should be simple and inexpensive.

Known headrest assemblies, which in particular have height adjustment and are simple to operate, are typically configured with an adjustment mechanism having a plurality of components, such as gear components. This requires a high amount of assembly and cost.

### SUMMARY

The present disclosure relates generally to a headrest guide and a headrest guide arrangement, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a first isometric view, a first exemplary embodiment of a headrest guide assembly of the headrest according to the disclosure.

FIG. 2 illustrates schematically and in an isometric view, an exemplary embodiment of the headrest according to the disclosure with a second exemplary embodiment of a corresponding headrest guide assembly.

FIG. 3 illustrates schematically and in an isometric exploded view, the embodiment of the headrest according to the disclosure according to FIG. 2.

FIG. 4A illustrates schematically and in a partially-cut view, the lock in its first state (locked state) used in the headrest assembly according to FIG. 3.

FIG. 4B illustrates the lock according to FIG. 4A in its second state (unlocked state).

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to generally adjustable headrest assemblies for a vehicle seat, in particular a motor vehicle seat. In particular, the disclosure relates to headrests for a vehicle seat having a specific headrest guide assembly and a headrest guide assembly for such headrests.

One problem addressed by the present disclosure is to specify a headrest assembly for a vehicle, wherein the headrest is securely, easily, and quickly adjustable to a position that is optimal for the vehicle occupant, simple to construct in terms of manufacture and assembly, and cost-effective to implement.

Accordingly, the disclosure relates in particular to a headrest for a vehicle seat, wherein the headrest comprises two headrest rods or headrest rod portions, which extend at least substantially parallel and on which a head cushion of the headrest is or can be arranged.

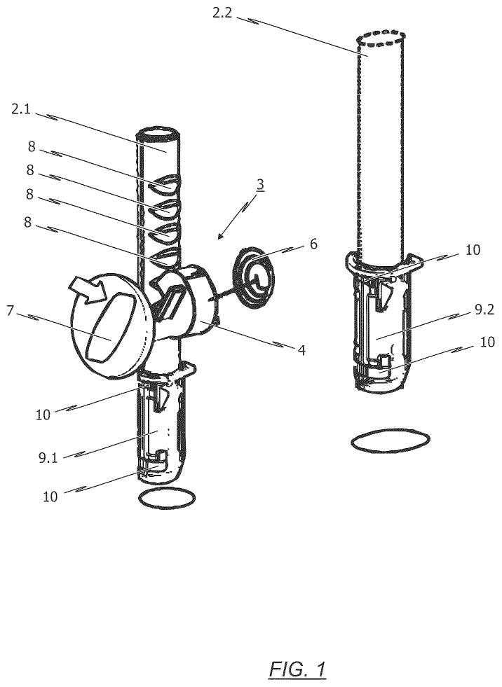

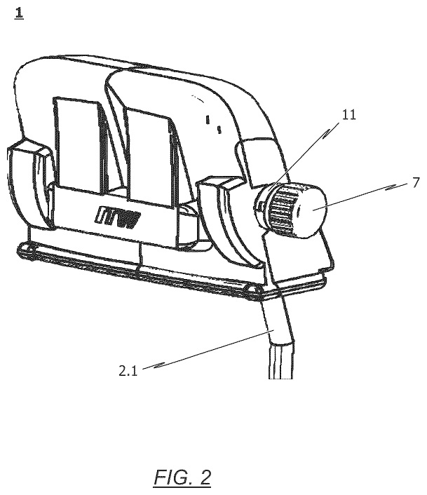

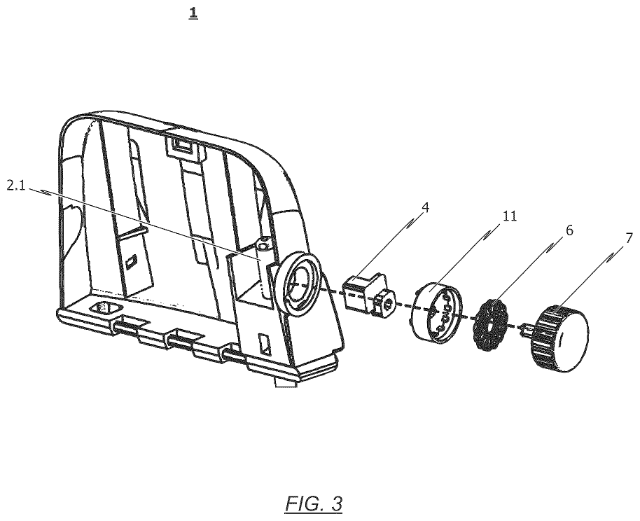

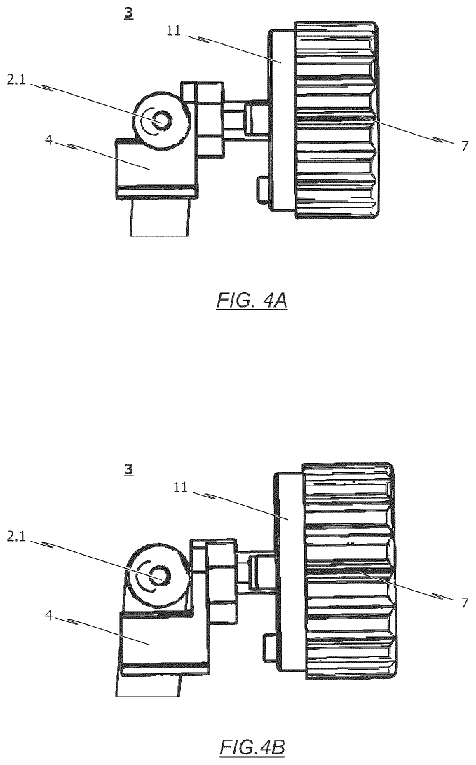

FIGS. 1 through 4B illustrate various views of exemplary embodiments of the headrest and its guide assembly according to the disclosure. FIG. 1 illustrates a first example of a headrest guide assembly in a schematic isometric view. FIG. 2 illustrates another example of the headrest, this time featuring a second embodiment of a corresponding guide assembly, also shown in an isometric view. FIG. 3 illustrates an exploded isometric view of the headrest embodiment shown in FIG. 2. FIGS. 4A and 4B illustrate the locking mechanism used in the headrest assembly from FIG. 3: FIG. 4A illustrates the lock in its engaged (locked) state, while FIG. 4B illustrates it in its disengaged (unlocked) state, with both views presented in partially cut schematic form.

The exemplary embodiment of the headrest 1 according to the disclosure and the headrest guide assembly according to the disclosure, as shown in the enclosed drawings, are wherein a lock 3 is used, being in particular manually actuatable, which can be transferred between a first state and a second state, wherein the first state of the lock 3 corresponds to a locked state in which an adjustability of the headrest rods 2.1, 2.2 in relation to the headrest guide assembly is blocked, and wherein the second state of the lock 3 corresponds to an unlocked state in which an adjustability of the headrest rods 2.1, 2.2 in relation to the headrest guide assembly is possible. The manually actuatable lock 3, in its first state, acts exclusively on only one of the two headrest rods 2.1, 2.2 of the headrest 1.

The headrest according to the disclosure further comprises a headrest guide assembly via which the headrest rods or headrest rod portions are or can be received on, and in particular in, a seatback of the vehicle seat in such a way that the headrest rods or headrest rod portions with the head cushion of the headrest arranged on the headrest rods or headrest rod portions can be adjusted, and in particular slid, in a longitudinal direction of extension of the headrest rods or headrest rod portions in relation to the headrest guide assembly between a first position and at least one second position.

In order to determine an adjustment position of the head rest, a lock is used, being in particular manually actuatable, which can be moved between a first state and a second state. The first state of the lock corresponds to a locked state in which an adjustable position of the headrest rods and/or headrest rod portions relative to the headrest guide assembly is blocked. Conversely, the second state of the lock corresponds to an unlocked state in which an adjustability of the headrest rods or headrest rod portions relative to the headrest guide assembly is possible.

The disclosure is characterized in particular in that the in particular manually actuatable lock, in particular in its first state, acts exclusively on only one of the two headrest rods or headrest rod portions.

By having only one of the two headrest rods or headrest rod portions associated with the lock, the overall headrest assembly is simplified. The headrest assembly can in particular be implemented with a particularly small number of components.

According to implementations of the present disclosure, it is provided that the in particular manually actuatable lock comprises an engaging element, which in the first state of the lock is engaged with the one of the two headrest rods or with the one of the two headrest rod portions. In addition, it is expedient for the lock to have a biasing element that biases the lock into its first state.

According to further developments of the last mentioned design variant, it is provided that the in particular manually actuatable lock comprises a rotary knob, which is configured such that, when the rotary knob is actuated or rotated, the lock is transferred into its second state and an engagement between the engaging element and the one headrest rod or the one headrest rod portion is released.

The biasing element preferably has a dual function: on the one hand, the biasing element serves to bias the lock into its first state. On the other hand, the biasing element is preferably configured so as to bias the rotary knob into its unactuated position.

According to preferred implementations of the headrest according to the disclosure, the biasing element is configured as a rotary spring or torsion spring. Of course, other design variants can also be considered here.

According to preferred implementations of the headrest according to the disclosure, the engaging element is configured as a lever element arranged in a rotatable manner about an axis of rotation. The axis of rotation preferably extends perpendicular to the longitudinal extension direction of the headrest rods or headrest rod portions.

In particular, the engaging element is configured as a lever element that is rotatably arranged such that, in the first state the lock, in a setting notch of the one headrest rod or headrest portion, the lever element engages into the headrest rod or headrest rod portion.

In one design variant of the headrest according to the disclosure, it is provided that the rotary knob of the lock is mounted rotationally at least partially or regionally in a housing of the lock about the axis of rotation of the lever element, wherein a rotary spring, in particular made of plastic, is preferably arranged between the housing of the lock and the rotary knob.

With regard to the engaging element of the headrest according to the disclosure, it is particularly preferred that it has a passage opening through which the headrest rod or the headrest rod portion is guided.

According to embodiments of the headrest according to the disclosure, it is provided in this context that a wall region of the through-opening facing the rotary knob has a complementary contour that is at least partially or regionally adapted to the shape, in particular the cross-sectional shape, of the one headrest rod or the headrest rod portion.

The headrest guide assembly preferably comprises a first guide sleeve body, which is associated with a first headrest rod or a first headrest rod portion of the two headrest rods or two headrest rod portions and in which the first headrest rod or the first headrest rod portion is or can be at least partially or regionally received.

In a similar manner, it is expedient for the headrest guide assembly to further comprise a second guide sleeve body, which is associated with a second headrest rod or second headrest rod portion of the two headrest rods or two headrest rod portions and in which the second headrest rod or second headrest rod portion is or can be at least partially or regionally received.

Preferably, the headrest guide assembly comprises a tolerance compensation mechanism for compensating any tolerance fluctuations in the distances between the two headrest rods or headrest rod portions extending substantially parallel.

According to design variants of the headrest according to the disclosure, it is provided that the first guide sleeve body is or can be received at least partially or regionally in a first receptacle configured in or on the seatback of the vehicle seat. Likewise, the second guide sleeve body is or can be received at least partially or regionally in a second receptacle configured in or on the seatback of the vehicle seat.

To compensate for any tolerance fluctuations in the distances between the two at least substantially parallel headrest rods or headrest rod portions, the first receptacle has as a tolerance compensation mechanism a cross-sectional geometry and size corresponding to the cross-sectional geometry and size of the first guide sleeve, while the second receptacle has a longitudinal cross-sectional geometry, wherein the longitudinal sides of the elongated hole extend in the direction of the first receptacle and the narrow sides of the elongated hole end in semi-circles whose diameters correspond to the width of the elongated hole and are adapted to the size and cross-sectional geometry of the second guide sleeve.

Alternatively or additionally, it is contemplated that the first guide sleeve body comprises an internal axial passage, which is configured to at least partially or regionally receive the first headrest rod or the first headrest rod portion, wherein the second guide sleeve body also comprises an internal axial passage, which is configured to at least partially or regionally receive the second headrest rod or the second headrest rod portion, respectively.

To compensate for any diameter tolerances present, the axial passageway of the first guide sleeve body should have a cross-sectional geometry and size, corresponding to the cross-sectional geometry and size of the first headrest rod and the first headrest rod portion, respectively, during the axial passage of the second guide sleeve body at least regionally, has a longitudinal cross-sectional geometry, wherein the longitudinal sides of the oblong hole extend toward the first guide sleeve body and the narrow sides of the oblong hole are terminated by semi-circles, whose diameter corresponds to the width of the oblong hole and is adapted to the size and cross-sectional geometry of the second headrest rod and the second headrest rod portion, respectively.

However, as an alternative to a longitudinal cross-sectional geometry, an egg-shaped or oval cross-sectional geometry or the like is also contemplated.

Preferably, the two guide sleeve bodies are associated with a diameter tolerance compensation mechanism for the corresponding headrest rod or for the corresponding headrest rod portion. Here, it is expedient for the diameter tolerance compensation mechanism to comprise at least one resilient element arranged on the outer surface or inner surface of the first and second guide sleeve body. The at least one resilient element can be configured as an elastomer element.

The lock 3 comprises an engaging element 4, which, in the first state of the lock 3, engages with the one of the two headrest rods 2.1, 2.2. Furthermore, the lock 3 comprises a biasing element 6 (spring) which biases the lock 3 into its first state.

The design variants of the headrest assembly according to the disclosure as shown in the drawings are further wherein the lock 3 comprises a rotary knob 7, which is arranged in such a way that, when actuated, i.e., rotated, the rotary button 7 transfers the lock 3 into its second state, and an engagement between the engaging element 4 and the one headrest rod 2.1 is released. The aforementioned biasing element 6 also serves to bias the rotary knob 7 into its unactuated position.

As can be seen from the illustration in FIG. 1, the biasing element is preferably configured as a torsion spring.

Also, in the first design variant shown schematically in FIG. 1, the engaging element 4 is designed as a lever element that is configured so as to be rotatable about an axis of rotation that preferably extends perpendicular to the longitudinal direction of extension of the headrest rods 2.1, 2.2 and which, in the first state of the lock 3, is engaged with the headrest rod 2.1 in a setting notch 8 of the one headrest rod 2.1.

In FIG. 2 through FIG. 4B, a further (second) design variant of the disclosure is shown.

As in the first embodiment according to FIG. 1, in the further design variant, a lock 3 is provided, which in its first state (locked state) only acts on one of the two headrest rods (here, on the headrest rod 2.1). The lock 3 comprises an engaging element 4, which, in the first state of the lock 3, engages with the headrest rod 2.1. In addition, a biasing element 6 in the form of a spring plate made of plastic is used, which biases the lock 3 into its first state.

The lock 3 comprises a rotary knob 7, which is arranged in such a way that, when actuated, i.e., rotated, the rotary button 7 transfers the lock 3 into its second state, and an engagement between the engaging element 4 and the headrest rod 2.1 is released. The biasing element 6 is configured so as to bias the rotary knob 7 into its unactuated position.

The exploded view according to FIG. 3 shows in particular that the engaging element 4 is designed as a lever element that is configured so as to be rotatable about an axis of rotation that extends perpendicular to the longitudinal direction of extension of the headrest rod 2.1 and which, in the first state of the lock 3, is engaged with the headrest rod 2.1 in a setting notch 8 of the headrest rod 2.1.

However, it is of course also contemplated that the headrest rod is designed without a corresponding setting notch 8.

It can also be seen in the exploded view according to FIG. 3 that the rotary knob 7 of the lock 3 is mounted rotatably at least partially or regionally in a housing 11 of the lock 3 about the axis of rotation of the lever element, wherein the rotary spring is arranged between the housing 11 of the lock 3 and the rotary knob 7.

The headrest guide assemblies of the embodiments shown in the drawings each comprise a first guide sleeve body 9.1 and a second guide sleeve body 9.2. The first guide sleeve body 9.1 is associated with a first headrest rod 2.1 of the two headrest rods 2.1, 2.2, wherein the first headrest rod 2.1 is or can be received at least partially or regionally in the first guide sleeve body 9.1.

Likewise, the second guide sleeve body 9.2 is associated with a second headrest rod 2.2 of the two headrest rods 2.1, 2.2, wherein the second headrest rod 2.2 is or can be received at least partially or regionally in the second guide sleeve body 9.2.

In the design variant shown in FIG. 1, the headrest guide assembly comprises a tolerance compensation mechanism for compensating any tolerance fluctuations in the distances between the two headrest rods 2.1, 2.2 extending substantially parallel.

Specifically, with regard to the tolerance compensation, it is provided that (as indicated in FIG. 1) the first guide sleeve body 9.1 comprises an internal axial passage, which is configured so as to at least partially or regionally receive the first headrest rod 2.1, wherein the second guide sleeve body 9.2 comprises an internal axial passage, which is configured so as to at least partially or regionally receive the second headrest rod 2.2, wherein, for compensating any diameter tolerances and/or for compensating any tolerance fluctuations present between the distances of the two headrest rods 2.1, 2.2 extending at least substantially parallel to one another, the axial passage of the first guide sleeve body 9.1 has a cross-sectional geometry and size corresponding to the cross-sectional geometry and size of the first headrest rod 2.1, while the axial passage of the second guide sleeve body 9.2 has at least regionally an at least substantially elongated hole-shaped cross-sectional geometry, wherein the longitudinal sides of the elongated hole extend in the direction of the first guide sleeve body 9.1 and the narrow sides of the elongated hole end in semi-circles whose diameters correspond to the width of the elongated hole and are adapted to the size and cross-sectional geometry of the second headrest rod 2.2.

In the design variants shown in the drawings, the guide sleeve bodies 9.1, 9.2 of the headrest guide assemblies are configured with an integrated diameter tolerance compensation. Specifically, the diameter tolerance compensation is formed by at least one resilient element 10, which is formed on the outer surface or inner surface of the corresponding guide sleeve body 9.1, 9.2.

The disclosure is not limited to the embodiments shown in the drawings, but results when all of the features disclosed herein are considered together.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting. Therefore, the present disclosure in this specification may be used to solve other technical problems and may have other technical effects. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

### LIST OF REFERENCE NUMERALS

1 Headrest
2.1 First Headrest Rod
2.2 Second Headrest Rod
3 Lock
4 Engaging Element
6 Biasing Element
7 Rotary Knob
8 Setting Notch
9.1 First Guide Sleeve Body
9.2 Second Guide Sleeve Body
10 Resilient Element/Elastomer Element
11 Housing

What is claimed is:

1. A headrest (1) for a vehicle seat comprising:
two headrest rods (2.1, 2.2) or headrest rod portions that extend at least substantially parallel and on which a head cushion of the headrest (1) is or can be arranged;
a headrest guide assembly via which the headrest rods (2.1, 2.2) or headrest rod portions are or can be received on or in a seatback of the vehicle seat in such a way that the headrest rods (2.1, 2.2) or headrest rod portions with the head cushion of the headrest (1) arranged on the headrest rods (2.1, 2.2) or headrest rod portions can be adjusted, and slid, in a longitudinal direction of extension of the headrest rods (2.1, 2.2) or headrest rod portions in relation to the headrest guide assembly between a first position and at least one second position; and
a manually actuatable lock (3) that can be transferred between a first state and a second state,
wherein the first state of the manually actuatable lock (3) corresponds to a locked state in which an adjustability of the headrest rods (2.1, 2.2) or headrest rod portions in relation to the headrest guide assembly is blocked,
wherein the second state of the manually actuatable lock (3) corresponds to an unlocked state in which an adjustability of the headrest rods (2.1, 2.2) or headrest rod portions in relation to the headrest guide assembly is possible, and
wherein the manually actuatable lock (3), in its first state, acts exclusively on only one of the two headrest rods (2.1, 2.2) or headrest rod portions.

2. The headrest (1) according to claim 1,
wherein the manually actuatable lock (3) comprises an engaging element (4), which in the first state of the manually actuatable lock (3) is engaged with the one of the two headrest rods (2.1, 2.2) or with the one of the two headrest rod portions, and a biasing element (6), which biases the manually actuatable lock (3) into its first state.

3. The headrest (1) according to claim 2,
wherein the manually actuatable lock (3) comprises a rotary knob (7), which is configured such that, when the rotary knob (7) is actuated, the manually actuatable lock (3) is transferred into its second state and an engagement between the engaging element (4) and the one headrest rod (2.1) or the one headrest rod portion is released.

4. The headrest (1) according to claim 3, wherein the biasing element (6) is configured so as to bias the rotary knob (7) into its unactuated position.

5. The headrest (1) according to claim 3, wherein the biasing element (6) is configured as a rotational or torsion spring.

6. The headrest (1) according to claim 3, wherein the engaging element (4) is designed as a lever element that is configured so as to be rotatable about an axis of rotation that extends perpendicular to the longitudinal direction of extension of the headrest rods (2.1, 2.2) or headrest rod portions and which, in the first state of the manually actuatable lock (3), is engaged with the headrest rod (2.1) or headrest rod portion in a setting notch (8) of the headrest rod (2.1) or headrest rod portion.

7. The headrest (1) according to claim 3,
wherein the rotary knob (7) of the manually actuatable lock (3) is mounted rotationally at least partially or regionally in a housing (11) of the manually actuatable lock (3) about the axis of rotation of the lever element, and
wherein a rotational spring made of plastic is arranged between the housing (11) of the manually actuatable lock (3) and the rotary knob (7).

8. The headrest (1) according to claim 1,
wherein the headrest guide assembly comprises a first guide sleeve body (9.1), which is associated with a first headrest rod (2.1) or a first headrest rod portion of the two headrest rods (2.1, 2.2) or two headrest rod portions and in which the first headrest rod (2.1) or the first headrest rod portion is or can be at least partially or regionally received; and
wherein the headrest guide assembly comprises a second guide sleeve body (9.2), which is associated with a second headrest rod (2.2) or second headrest rod portion of the two headrest rods (2.1, 2.2) or two headrest rod portions and in which the second headrest rod (2.2) or second headrest rod portion is or can be at least partially or regionally received.

9. The headrest (1) according to claim 8, wherein the headrest guide assembly comprises a tolerance compensation mechanism for compensating any tolerance fluctuations in the distances between the two headrest rods (2.1, 2.2) or headrest rod portions extending substantially parallel.

10. The headrest (1) according to claim 8,
wherein the first guide sleeve body (9.1) is or can be received at least partially or regionally in a first receptacle configured in or on the seatback of the vehicle seat,
wherein the second guide sleeve body (9.2) is or can be received at least partially or regionally in a second receptacle configured in or on the seatback of the vehicle seat,
wherein, as a tolerance compensation mechanism for compensating any tolerance fluctuations in the distances between the two at least substantially parallel headrest rods (2.1, 2.2) or headrest rod portions, the first receptacle has a cross-sectional geometry and size corresponding to the cross-sectional geometry and size of the first guide sleeve, while the second receptacle has a longitudinal cross-sectional geometry, and
wherein the longitudinal sides of the elongated hole extend in the direction of the first receptacle and the narrow sides of the elongated hole end in semi-circles whose diameters correspond to the width of the elongated hole and are adapted to the size and cross-sectional geometry of the second guide sleeve.

11. The headrest (1) according to claim 8,
wherein the first and/or second guide sleeve bodies (9.1, 9.2) comprises an internal axial passage, which is configured so as to at least partially or regionally receive the corresponding headrest rod (2.1, 2.2) or corresponding headrest rod portion, and
wherein the first and/or second guide sleeve body (9.1, 9.2) comprises a diameter tolerance compensation mechanism for the corresponding headrest rod (2.1, 2.2) or corresponding headrest rod portion.

12. The headrest (1) according to claim 11, wherein the diameter tolerance compensation mechanism comprises at least one resilient element (10) arranged on the outer surface or inner surface of the first and second guide sleeve body, respectively.

13. The headrest (1) according to claim 11,
wherein the first guide sleeve body (9.1, 9.2) comprises an internal axial passage, which is configured so as to at least partially or regionally receive the first headrest rod (2.1, 2.2) or first headrest rod portion,
wherein the second guide sleeve body (9.1, 9.2) comprises an internal axial passage, which is configured so as to at least partially or regionally receive the second headrest rod (2.1, 2.2) or second headrest rod portion,
wherein, for compensating any diameter tolerances, the axial passage of the first guide sleeve body has a cross-sectional geometry and size corresponding to the cross-sectional geometry and size of the first headrest rod (2.1, 2.2) or first headrest rod portion, while the axial passage of the second guide sleeve body has at least regionally a longitudinal cross-sectional geometry, and
wherein the longitudinal sides of the elongated hole extend in the direction of the first guide sleeve body and the narrow sides of the elongated hole end in semi-circles whose diameters correspond to the width of the elongated hole and are adapted to the size and cross-sectional geometry of the second headrest rod (2.1, 2.2) or second headrest rod portion.
